(19) United States
(12) Patent Application Publication
(10) Pub. No.: US 2006/0077317 A1
(43) Pub. Date: Apr. 13, 2006

(54) Liquid crystal display showing colors by a fluorescent layer

(76) Inventor: Sheng-Feng Chen, Taipei Shien (TW)

Correspondence Address: RABIN & Berdo, PC, 1101 14TH STREET, NW, SUITE 500, WASHINGTON, DC, 20005, US

(21) Appl. No.: 11/139,514

(22) Filed: May 31, 2005

(30) Foreign Application Priority Data
Oct. 8, 2004 (TW) 93130671

(51) Int. Cl. G02F 1/1335

(52) U.S. Cl. 349/70

(57) ABSTRACT

A liquid crystal display (LCD) includes a first substrate, a second substrate, a fluorescent layer, a backlight plate, a first polarizer, and a second polarizer. The second substrate is disposed in parallel with the first substrate. Liquid crystals are filled between the first substrate and the second substrate. A first polarizer is located at an outer side of the first substrate while a second polarizer located at an outer side of the second substrate. A fluorescent layer, having a fluorescent material, is disposed at an inner side of the first substrate. A backlight plate is disposed at an outer side of the second substrate. The backlight plate has a lamp for generating a beam of excited light, and the beam of excited light excites the fluorescent material to generate color light.

This application claims the benefit of Taiwan application Serial No. 93130671, filed Oct. 8, 2004, the subject matter of which is incorporated herein by reference.

### BACKGROUND OF THE INVENTION

1. Field of the Invention

The invention relates in general to a liquid crystal display, and more particularly to a liquid crystal display showing colors by a fluorescent layer.

2. Description of the Related Art

A liquid crystal display (LCD) is lighter and occupies less space than a cathode-ray tube (CRT) display. With regard to users, the LCD has more elasticity in usage and is easier for carriage. Therefore, the LCD is becoming a mainstream display in place of the CRT display.

Conventionally, the LCD structure includes an upper glass substrate, a color filter, a lower glass substrate, and a backlight plate. Liquid crystals are filled between the upper and lower glass substrates, and pixel electrodes configured on the lower glass substrate for controlling liquid crystals' rotating angles to change display's transparency. White light radiated from the backlight plate passes liquid crystals and the color filter to generate colors for observers.

However, the conventional LCD has a difficulty in improving its luminance owing that a part of light is filtered out by the color filter. The color filter includes red, green, and blue crystal lattices. When white light passes the red crystal lattices of the color filter, blue and green components of the light are filtered out and only the red component passes the filter. When the white light passes the blue crystal lattices of the color filter, red and green components of the light are filtered out and only the blue component passes the filter. Similarly, when the white light passes the green crystal lattices of the color filter, red and blue components of the light are filtered out and only the red component passes the filter. Therefore, white light radiated from the backlight plate loses some energy after passing the liquid crystals and has only one-third energy left after passing the color filter, thereby greatly reducing the display's luminance.

Furthermore, the conventional LCD has another disadvantage that it has a narrow viewing-angle. Because manufacturing color filters costs about 24% in the whole LCD process, the conventional LCD using color filters for showing colors has disadvantage of high cost, narrow viewing-angle, and poor luminance.

### SUMMARY OF THE INVENTION

It is therefore an object of the invention to provide a LCD for enhancing the luminance and viewing-angle of the LCD and reducing LCD manufacturing cost.

The invention achieves the above-identified object by providing a LCD. The LCD includes a first substrate, a second substrate, a fluorescent layer, a backlight plate, a first polarizer, and a second polarizer. The second substrate is disposed in parallel with the first substrate. Liquid crystals are filled between the first substrate and the second substrate. A first polarizer is located at an outer side of the first substrate while a second polarizer located at an outer side of the second substrate. A fluorescent layer, having a fluorescent material, is disposed at an inner side of the first substrate. A backlight plate is disposed at an outer side of the second substrate. The backlight plate has a lamp for generating a beam of excited light, and the beam of excited light excites the fluorescent material to generate color light.

The invention achieves the above-identified object by providing a method for manufacturing a LCD. The method includes the steps of providing a first substrate and a second substrate; disposing a fluorescent material at an inner side of the first substrate, wherein the fluorescent material comprises red fluorescent powder, blue fluorescent powder, and green fluorescent powder; combining the first substrate and the second substrate; pouring liquid crystals in between the first substrate and the second substrate, and respectively attaching a first polarizer and a second polarizer to outer sides of the first substrate and the second substrate; and disposing a backlight plate at an outer side of the second polarizer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a schematic cross-sectional diagram of a LCD according to a preferred embodiment of the invention.

FIG. 2 is a schematic diagram of showing colors by using the LCD in FIG. 1.

FIG. 3 is a flow chart of the method for manufacturing a LCD.

### DETAILED DESCRIPTION OF THE INVENTION

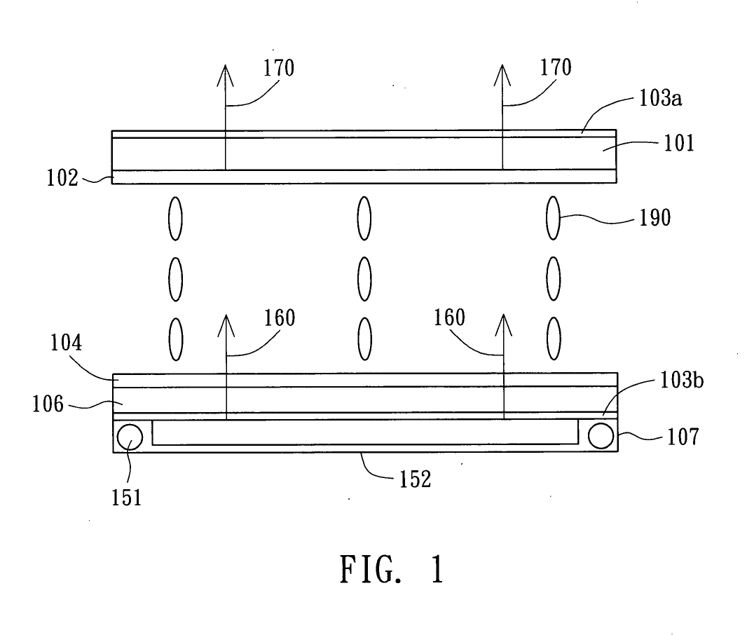

FIG. 1 illustrates a schematic cross-sectional diagram of a LCD according to a preferred embodiment of the invention. The LCD includes a first substrate 101, a fluorescent layer 102, a number of pixel electrodes 104, a second substrate 106, a backlight plate 107, a first polarizer 103a, and a second polarizer 103b. The first substrate 101 and the second substrate 106 are glass substrates configured in parallel, and liquid crystals 190 are filled between the two substrates 101 and 106. The fluorescent layer 102 is disposed at an inner side of the first substrate 101 corresponding to the second substrate 106, while the backlight plate 107 disposed at an outer side of the second substrate 106. The pixel electrodes 104 are configured in matrix array at an inner side of the second substrate 106, corresponding to the first substrate 101. The first polarizer 103a and the second polarizer 103b are respectively located at the outer sides of the first substrate 101 and the second substrate 106.

The backlight plate 107 has a lamp 151, a reflector 152, and the lamp 151 contains mercury vapor. Conventionally, fluorescent powder is ordinary smeared on the tube-wall of the lamp 151. When mercury atoms in the lamp 151 are hit by electrons to radiate ultraviolet light, the fluorescent powder will absorb the ultraviolet light and then generate white light. However, in the embodiment, fluorescent powder is not smeared on the tube-wall of the lamp 151. That is, the tube-wall of the lamp 151 has no fluorescent powder and maintains transparency. When the lamp 151 is applied by a voltage, electrons collide and excite the mercury atoms in the lamp 151. When excited electrons of the mercury atoms return to their original energy states, ultraviolet light 160 is generated to penetrate the tube-wall of the lamp 151 and then pass the liquid crystals 190.

The generated ultraviolet light 160 passing the second polarizer 103b, the second substrate 106, and pixel electrodes 104, remains invisible light. After the light 160 enters the fluorescent layer 102, it is absorbed by the fluorescent layer 102 to radiate visible light 170.

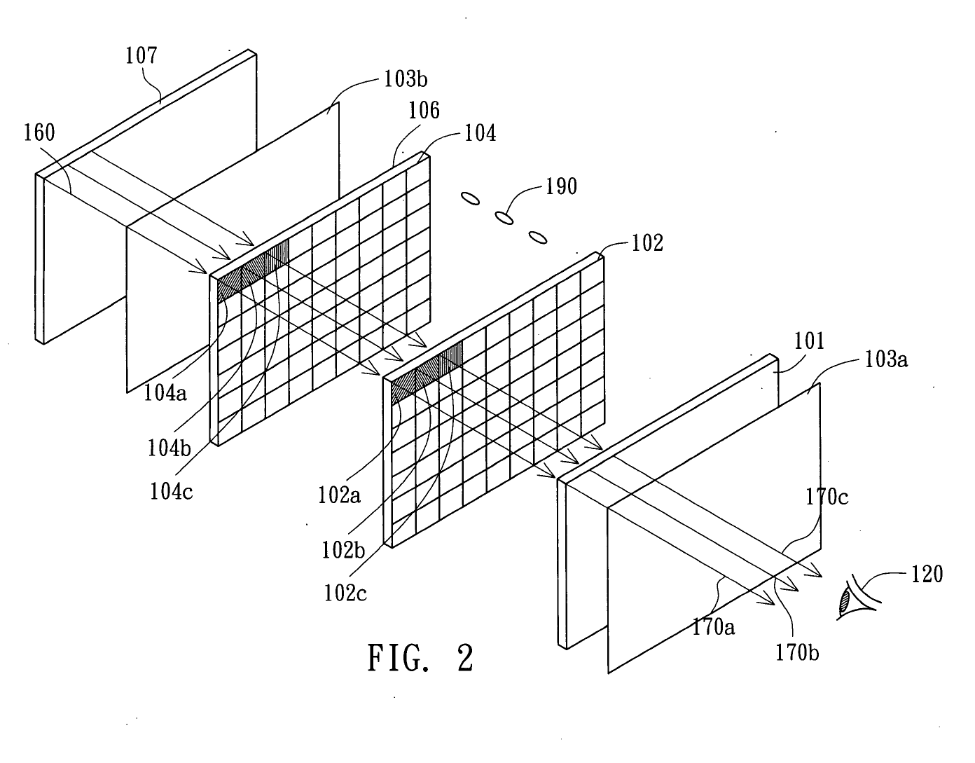

Referring to FIG. 2, a schematic diagram of showing colors by using the LCD in FIG. 1 is shown. The fluorescent layer 102 includes red fluorescent powder 102a, blue fluorescent powder 102b, and green fluorescent powder 102c respectively corresponding to a pixel electrode 104a, a pixel electrode 104b, and a pixel electrode 104c. The ultraviolet light 160 penetrates the second polarizer 103b, the second substrate 106, and the pixel electrode 104 to remain invisible light, and then enters the fluorescent layer 102 to generate visible light 170 including red light, green light, and blue light. Red fluorescent powder 102a absorbs the ultraviolet light 160 to radiate red light 170a. Blue fluorescent powder 102b absorbs the ultraviolet light 160 to radiate blue light 170b while green fluorescent powder 102c absorbs the ultraviolet light 160 to radiate green light 170c.

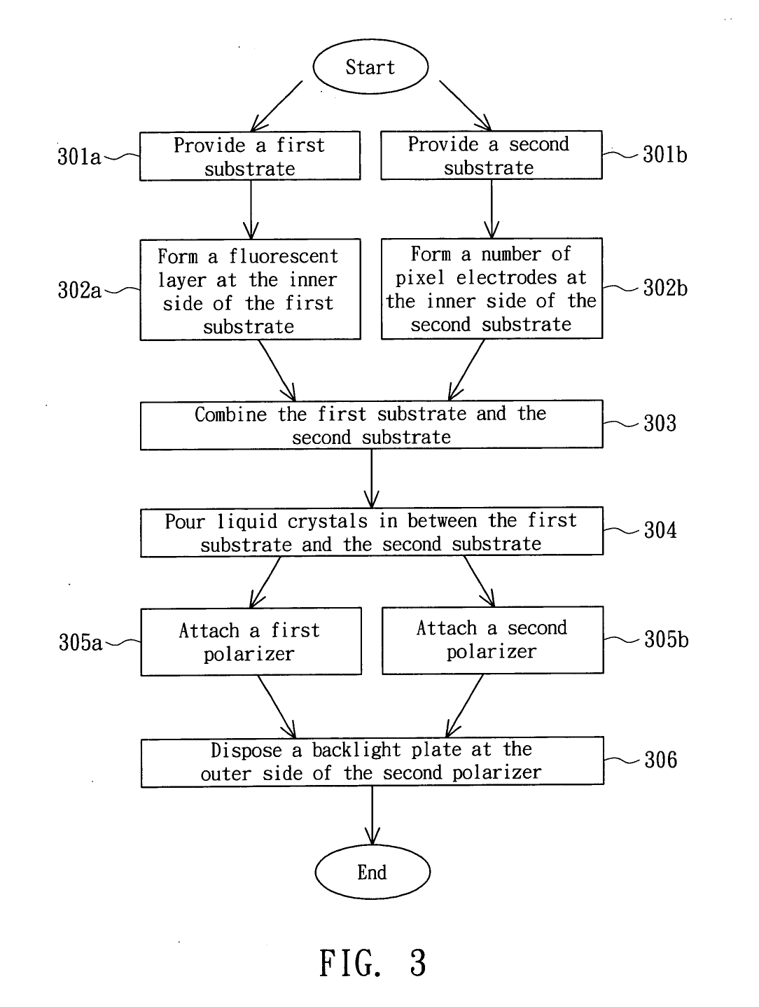

Referring to FIG. 3, a flow chart of the method for manufacturing a LCD is shown. In step 301a, provide the first substrate 101. In step 301b, provide the second substrate 106. In the step 302a next to the step 301a, form the fluorescent layer 102 at the inner side of the first substrate 101 corresponding to the second substrate 106. In the step 302b next to the step 301b, form a number of pixel electrodes 104 at the inner side of the second substrate 106. Afterwards, in step 303, combine the first substrate 101 and the second substrate 106. Next in step 304, pour liquid crystals in between the first substrate 101 and the second substrate 106. Attach the first polarizer 103a to the outer side of the first substrate 101 in step 305a and attach the second polarizer 103b to the outer side of the second substrate 106 in step 305b. The step 305a can be performed before or after the step 305b. Lastly, in step 306, dispose the backlight plate 107 at the outer side of the second polarizer 103b.

The LCD of the invention generates visible light by the fluorescent layer while the conventional LCD generates visible light by a backlight source. Therefore, the source generating visible light in the invention is closer to the LCD surface than a conventional light source. For this reason, the LCD of the invention has a wider viewing-angle than the conventional LCD.

Furthermore, the invention uses the fluorescent layer for transforming ultraviolet light to visible color light, without need to use the color filter to filter out unnecessary color components and show colors as in the prior art. Therefore, the LCD of the invention can have a higher luminance.

Moreover, the LCD manufacturing method of the invention is not quite different from that of a conventional LCD. As a result, the invention can save expensive cost of the color filter without changing manufacturing process a lot. Therefore, the LCD of the invention can not only enhance LCD luminance and viewing-angle, but also reduce manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD), essentially composed of:
a first substrate;
a second substrate, disposed in parallel with the first substrate, wherein a liquid crystal layer is configured between the first substrate and the second substrate;
a first polarizer, located at an outer side of the first substrate;
a second polarizer, located at an outer side of the second substrate;
a fluorescent layer, disposed at an inner side of the first substrate facing the liquid crystal layer, wherein the fluorescent layer has a fluorescent material; and
a backlight plate, disposed at an outer side of the second substrate, wherein the backlight plate has a lamp for generating a beam of excited light, and the beam of excited light excites the fluorescent material to generate color light.

2. The LCD according to claim 1, wherein the fluorescent material comprises red fluorescent powder, blue fluorescent powder, and green fluorescent powder for respectively generating the color light of a red color, a green color, and a blue color in accordance with the excited light.

3. The LCD according to claim 2, wherein a plurality of pixel electrodes in matrix array are disposed at an inner side of the second substrate facing the liquid crystal layer, and each pixel electrode is disposed in accordance with one of the red fluorescent powder, the blue fluorescent powder, and the green fluorescent powder.

4. The LCD according to claim 1, wherein the lamp comprises mercury atoms.

5. The LCD according to claim 1, wherein the excited light is ultraviolet light.

6. The LCD according to claim 1, wherein the first substrate is a glass substrate.

7. The LCD according to claim 1, wherein the second substrate is a glass substrate.

8. A method for manufacturing a liquid crystal display (LCD), comprising:
providing a first substrate and a second substrate;
disposing a fluorescent material at an inner side of the first substrate, wherein the fluorescent material comprises red fluorescent powder, blue fluorescent powder, and green fluorescent powder;
combining the first substrate and the second substrate;
pouring liquid crystals in between the first substrate and the second substrate, and attaching a first polarizer and a second polarizer to the combination of the first substrate and the second substrate; and
disposing a backlight plate at an outer side of the second polarizer.

9. The method according to claim 8, wherein the step of providing the second substrate comprises forming a plurality of pixel electrodes at an inner side of the second substrate.

10. The method according to claim 8, wherein the first substrate and the second substrate are glass substrates.
